(19) United States
(12) Patent Application Publication
(10) Pub. No.: US 2017/0186213 A1
(43) Pub. Date: Jun. 29, 2017

(54) METHODS AND APPARATUSES FOR DETERMINING LAYOUT OF STORED TEXTURE

(71) Applicant: SAMSUNG ELECTRONICS CO., LTD., Suwon-si (KR)

(72) Inventors: Minkyu JEONG, Yongin-si (KR); Jongpil SON, Seongnam-si (KR); Kwontaek KWON, Hwaseong-si (KR); Minyoung SON, Hwaseong-si (KR)

(73) Assignee: SAMSUNG ELECTRONICS CO., LTD., Suwon-si (KR)

(21) Appl. No.: 15/388,520

(22) Filed: Dec. 22, 2016

(30) Foreign Application Priority Data
Dec. 23, 2015 (KR) 10-2015-0185092

(51) Int. Cl. G06T 15/00; G06T 15/04; G06T 15/80

(52) U.S. Cl. CPC G06T 15/005; G06T 15/80; G06T 15/04

(57) ABSTRACT

A method of determining a layout of textures includes acquiring a pattern of using textures when pixel shading is performed, based on shader codes, determining a layout of the textures based on the acquired pattern, and storing the textures in a memory according to the determined layout. Also provided is a corresponding apparatus.

### CROSS-REFERENCE TO RELATED APPLICATIONS

This application claims the benefit under 35 USC 119(a) of Korean Patent Application No. 10-2015-0185092 filed on Dec. 23, 2015 in the Korean Intellectual Property Office, the entire disclosure of which is incorporated herein in its entirety by reference for all purposes.

### BACKGROUND

1. Field

The following description relates to methods for determining a layout of a stored texture. The following description also relates to apparatuses for determining a layout of a stored texture.

2. Description of Related Art

A texturing or a texture mapping technique is used as a way to obtain a realistic image in a 3-dimensional (3D) graphic system. In texturing or texture mapping, a two-dimensional (2D) image is laid onto a surface of a 3D object in order to provide a texture onto the surface of the 3D object. The texture is a 2D image and points in the texture are referred to as texels and correspond to pixels of the 2D image in a screen space. When a 3D graphic pipeline is performed and a surface of an object in a 3D space corresponding to each of the pixels of a 2D screen space is determined, texels each having a texture coordinate corresponding to the surface of the object are calculated, and accordingly, texture mapping between the pixels and the texels may be performed to apply the texture to the surface of the 3D object.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of determining a layout of textures includes acquiring a pattern of using the textures when pixel shading is performed, based on shader codes, determining a layout of the textures based on the acquired pattern, and storing the textures in a memory according to the determined layout.

The storing of the textures in the memory may include alternately storing the textures in units in the memory.

The units may include four texels in each of the textures.

The acquiring of the pattern may include acquiring the pattern during compiling of the shader codes.

Each of the textures may include at least one mipmap corresponding to each of the textures.

A reduction ratio between mipmaps may be 1/4.

The mipmaps may be stored in the memory in the order of the textures.

The memory may include dynamic random-access memories (DRAMs).

The method may further include performing pixel shading based on the textures stored in the memory.

The pattern may indicate in what order and what part of each of the textures are to be used when pixel shading is performed.

In another general aspect, there is provided a computer program embodied on a non-transitory computer readable medium, the computer program being configured to control a processor to perform the method of described above.

In another general aspect, a layout determining apparatus includes one or more processors configured to acquire a pattern of using textures when pixel shading is performed, based on shader codes, and determine a layout of the textures based on the acquired pattern and store the textures in a memory according to the determined layout.

The layout of the textures may include alternately storing the textures in units in the memory.

The units may include four texels in each of the textures.

The one or more processors may further be configured to acquire the pattern during compiling the shader codes.

Each of the textures may include at least one mipmap.

The memory may include dynamic random-access memories (DRAMs).

The one or more processors may further be configured to perform pixel shading based on the textures stored in the memory.

Other features and aspects will be apparent from the following detailed description, the drawings, and the claims.

### BRIEF DESCRIPTION OF THE DRAWINGS

FIG. 1 is a block diagram of a graphic processing system according to an embodiment.

FIG. 2 is a block diagram of a layout determining apparatus according to an embodiment.

FIG. 3 is a flowchart of a method of determining a texture layout according to an embodiment.

FIG. 4 is a drawing for illustrating a method of storing in a memory mipmaps corresponding to textures.

FIG. 5 is a block diagram for explaining an operation of a layout determining apparatus according to an embodiment.

FIG. 6 is a drawing for explaining a layout of textures according to an embodiment.

FIG. 7 is a block diagram of a configuration of a layout determining apparatus according to another embodiment.

FIG. 8 is a flowchart of a method of determining a stored texture layout according to another embodiment.

FIG. 9 is a block diagram of an example configuration of a layout determining apparatus according to another embodiment.

FIG. 10 is another block diagram of an example configuration of a layout determining apparatus according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The terms used in the embodiments below have been selected from terms currently widely used in the art by taking into account the functions in the current examples. Hoverer, the terms may be changed according to the intentions of those of ordinary skill in the art, case law precedents, or appearance of new technologies. Also, in some particular cases, some terms have been arbitrary selected by the applicant, and in this case, the terms are described in detail with respect to the corresponding parts of the embodiments. Accordingly, the terms used herein are not to be simply defined by their names, but are to be defined based on the meaning thereof and the content of the examples.

In the specification, when a certain part “comprises” or “includes” an element, unless the context clearly indicates otherwise, the part may further comprise or include another constituent elements without excluding the other constituent elements. Also, the terms “ . . . unit” or “ . . . module” described in the specification denote a unit that performs at least one function or operation and may be realized, for example, by hardware.

Reference is now made in further detail to embodiments, examples of which are illustrated in the accompanying drawings to facilitate understanding of one of ordinary skill in the art. However, examples may be embodied in many different forms and are not to be construed as being limited to the particular embodiments set forth herein.

Hereafter, the present examples are described more fully with reference to the accompanying drawings.

FIG. 1 is a block diagram of a graphic processing system 1 according to an embodiment.

Referring to the embodiment of FIG. 1, the graphic processing system 1 may include a central processing unit (CPU) 10, a graphic processing unit (GPU) 20, and a memory 30.

In the embodiment of FIG. 1, the CPU 10 transmits data to the GPU 20. For example, the data transmitted by the CPU 10 may be shader codes or compiled shader codes.

The memory 30 stores information or data required for processing data by the CPU 10 and the GPU 20, and also stores a result of data processing by the CPU 10 and the GPU 20. For example, the memory 30 may be a dynamic random-access memory (DRAM).

The GPU 20 performs a computation related to graphics rendering by using data transmitted from the CPU 10 and data stored in the memory 30. For example, the GPU 20 may include a vertex shader, a rasterizer, a pixel shader, and a frame buffer, as possible processing elements that perform a computation related to graphics rendering.

For example, the GPU 20 may perform pixel shading by using a texture stored in the memory 30. In such an example, the texture refers to image data used for determining colors of pixels included in a frame. In other words, the GPU 20 may determine colors of each of the pixels by using the texture stored in the memory 30 without performing a separate computation of color values of the pixels included in the frame.

In an example, a plurality of textures may be stored in the memory 30. For example, a plurality of mipmaps corresponding to a single texture may be stored in the memory 30. The plurality of mipmaps refers to a group of bitmap images including textures that may be consecutively reduced in advance.

When the GPU 20 renders an object, a mipmap may be used to express a distance. For example, when it is needed to present that an object is located close to an eye or another viewpoint, the GPU 20 may perform pixel shading by using a basic texture. When it is needed to present that the object is farther away from the eye, the GPU 20 may perform pixel shading by using a reduced texture. In such an example, it is possible to use a reduced texture because less detail is needed for successful pixel shading when an object is located further away. According to the above descriptions, the number of texels used for pixel shading is greatly reduced when compared to the example that the GPU 20 performs pixel shading by using only the basic textures. Accordingly, a rendering speed of the object by the GPU 20 may be increased. Using such an approach, less data is required to be processed, but no detail is sacrificed because the reduced textures are sufficient for examples whether the pixel shading occurs for an object that is farther away. Generally, since mipmaps have undergone an anti-aliasing process, a loss that may occur in the process of rendering an object by the GPU 20 is reduced, and also, a load required for rendering may be reduced.

In order to determine a color of a single unit pixel, the GPU 20 may use a plurality of textures stored in the memory 30. At this point, a time required for the GPU 20 to read the textures by accessing to the memory 30 may vary according to the configuration of the memory 30 or the state of how the textures are stored in the memory 30. For example, it is assumed that the memory 30 is configured of two channels, each of the channels includes 8 banks, and the size of a row buffer of each bank is 2 kilobytes (KB). When the GPU 20 consecutively accesses to the memory 30 to use the plurality of textures, if an address difference in the memory 30 is more than 4 KBs, the possibility of causing a row hit may be reduced. Also, if the address difference in the memory 30 to which the GPU 20 consecutively accesses is greater than 32 KBs, the possibility of causing a bank conflict may be increased.

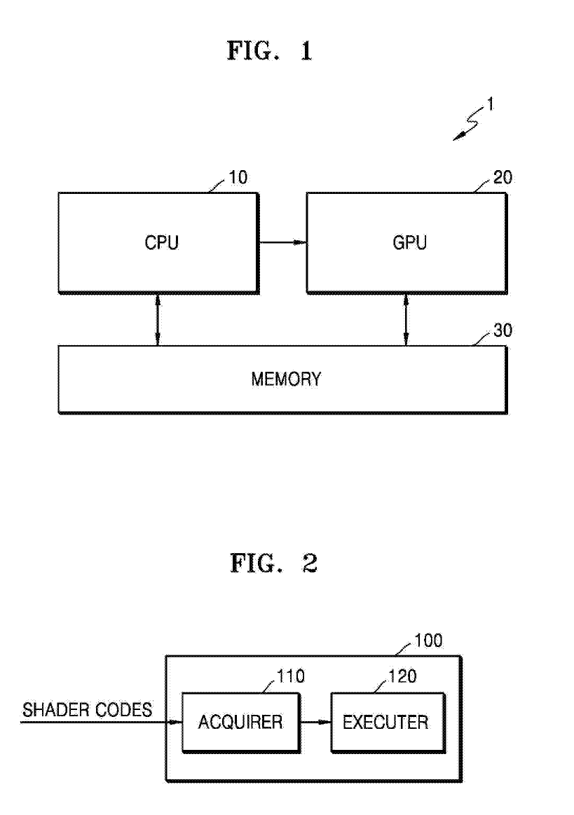

According to a layout determining apparatus that is described further below with reference to FIGS. 2 through 10, when pixel shading is performed, the layout determining apparatus determines the layout of textures in the memory 30 according to a pattern in which the textures are used. Also, the layout determining apparatus stores the result of the determined layout in the memory 30. Accordingly, when the GPU 20 consecutively accesses to the memory 30, the possibility of causing a row hit or a bank conflict may be reduced. In this example, the layout determining apparatus may be understood to be a part of the configuration of the CPU 10 or understood to be a part of the configuration of the GPU 20.

FIG. 2 is a block diagram of a layout determining apparatus 100 according to an embodiment.

Referring to FIG. 2, the layout determining apparatus 100 includes an acquisition unit or acquirer 110 and an execution unit or executer 120.

The layout determining apparatus 100 receives shader codes, and based on the shader codes, determines a layout of the textures in the memory 30. Also, the layout determining apparatus 100 stores the textures according to the determined layout.

In further detail, the acquirer 110 acquires a pattern in which the textures are to be used based on the shader codes. In this example, the pattern indicates in what order and what part of each of the textures are to be used when pixel shading is performed.

The executer 120 determines a layout of the textures based on the pattern acquired by the acquirer 110. Afterwards, the acquirer 110 stores the textures in the memory 30 according to the determined layout.

According to the embodiment described with reference to FIG. 2, the layout determining apparatus 100 stores textures in the memory 30 according to a pattern in which the textures are used when pixel shading is performed. Accordingly, a time required for the GPU 20 to read textures by accessing the memory 30 may be reduced. In other words, in accessing by the GPU 20 into the memory 30, the possibilities of causing a row hit and a bank conflict may be reduced. As a result, reading the relevant texture data may be minimized.

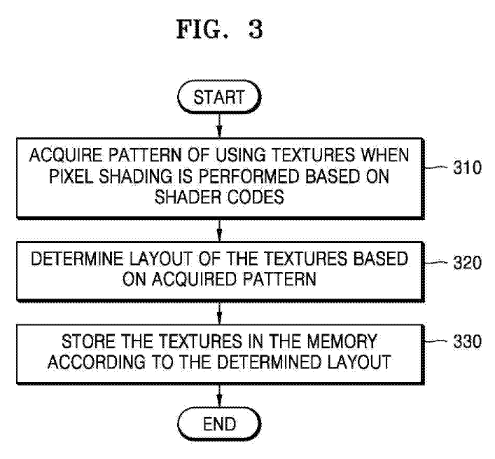

Hereinafter, an operation of the layout determining apparatus 100 is described further with reference to FIGS. 3 through 10.

FIG. 3 is a flowchart of a method of determining a texture layout according to an embodiment.

Referring to the embodiment of FIG. 3, the method of determining a layout textures may include time sequential operations performed in the graphic processing system 1 of FIGS. 1 and 2 or the layout determining apparatus 100. Accordingly, although some contents are omitted in the following descriptions for brevity, the contents described with respect to the graphic processing system 1 depicted in FIGS. 1 and 2 or the layout determining apparatus 100 may be applied to the method that is to be described with reference to FIG. 3.

In an operation 310, the method acquires a pattern in which textures are used when pixel shading is performed based on shader codes. For example, the acquirer 110 performs operation 310. In this example, each of the textures may be configured by gathering a plurality of mipmaps. In further detail, a plurality of mipmaps corresponding to a single texture may be stored in the memory 30.

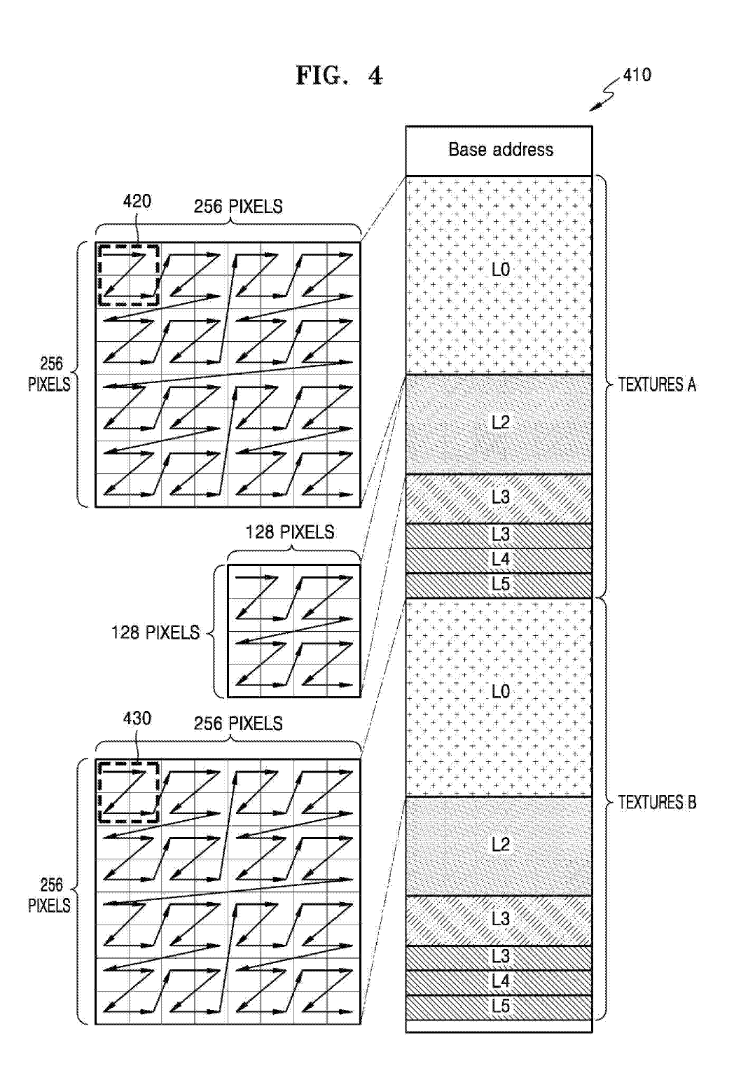

In such an example, an operation of storing mipmaps corresponding to textures in a memory is described further with reference to FIG. 4.

FIG. 4 is a drawing for explaining a method of storing mipmaps corresponding to a plurality of textures in a memory 410.

FIG. 4 shows an example of storing mipmaps corresponding to a plurality of textures in the memory 410. In further detail, it is depicted in the example of FIG. 4 that mipmaps corresponding to a texture A and mipmaps corresponding to a texture B are stored in the memory 410, and the texture A and texture B each respectively include six mipmaps L0, L1, L2, L3, L4, and L5.

It is depicted in the example of FIG. 4 that the memory 410 includes a single channel, but the memory 410 is not to be limited thereto. In other words, the memory 410 may also be configured to include a plurality of channels. Also, in FIG. 4, the number of mipmaps corresponding to a single texture is six. However, the number of mipmaps corresponding to a single texture may vary according to the size of the texture or the reducing ratio of the mipmaps, and the number of mipmaps corresponding to a single texture may be another appropriate value.

The mipmaps L0, L1, L2, L3, L4, and L5 are reduced bit map images of the texture A or the texture B at a reduction ratio. For example, the reduction ratio may be 1/4 of the mipmaps before reduction, such that each dimension of the mipmap is halved. For example, when it is assumed that the texture A is an image corresponding to 256*256 pixels, the mipmap L0, the mipmap L1, the mipmap L2, and the mipmap L3 respectively are images corresponding to 256*256 pixels, 128*128 pixels, 64*64 pixels, and 32*32 pixels, and so on.

Generally, the mipmaps are stored in the memory 410 in the order of the textures. In other words, the mipmaps are stored in the memory 410 in the order of the textures without taking into account the pattern or order in which the textures are used when pixel shading itself is actually performed. For example, referring to the example of FIG. 4, after the mipmaps corresponding to the texture A are stored in the memory 410, the mipmaps corresponding to the texture B may be sequentially stored in the memory 410.

Accordingly, when the texture A, or the mipmaps corresponding to the texture A, and the texture B, or mipmaps corresponding to the texture B, are simultaneously required for the determination of a color value of a specific pixel, according to the storing state of the mipmaps in the memory 410, the possibility of causing a row hit is reduced or the possibility of a bank conflict may be increased when the GPU 20 accesses to the memory 410.

Also, in general, in order to be determined a color value of a specific pixel, some texels 420 and 430 included in the textures are required. For example, when a color value of a pixel is determined based on the textures A and B in order to be determined a color value of a specific pixel, a portion of texels 420 included in the mipmap L0 of the texture A and a portion of texels 430 included in the mipmap L0 of the texture B may also be used.

Accordingly, while storing the textures in the memory 410, if a pattern in which the textures are used when pixel shading is performed is not taken into account, the possibility of causing a row hit is reduced or the possibility of a bank conflict may be increased when the GPU 20 accesses to the memory 410.

Referring to FIG. 3 again, the acquirer 110 may acquire a pattern in which the textures are used as compiling shader codes. Alternatively put, the acquirer 110 compiles the shader codes. Also, the acquirer 110 may obtain a pattern that expresses how textures of a plurality of textures are to be used when pixel shading is performed based on the complied shader codes.

In an operation 320, the method determines a layout of textures based on the pattern acquired by the acquirer 110. For example, the executer 120 may perform operation 320. In an example, the layout of the textures denotes a state of storing the textures or mipmaps corresponding to the textures in the memory 410. For example, the executer 120 may determine a layout of the textures or mipmaps corresponding to the textures so that the textures are alternately stored with a predetermined unit in the memory 410. In this example, the predetermined unit may refer to four texels included in the textures or mipmaps corresponding to the textures.

According to the embodiment described with reference to FIG. 4, the GPU 20 may take into account four texels adjacent to the texture or mipmaps corresponding to the texture to determine a color value of a specific pixel. Accordingly, the executer 120 may determine a layout so that the four texels of the texture adjacent to each other or mipmaps corresponding to the texture are stored properly.

In an operation 330, the method stores the textures in a memory according to the determined layout. For example, the executer 120 may perform operation 330.

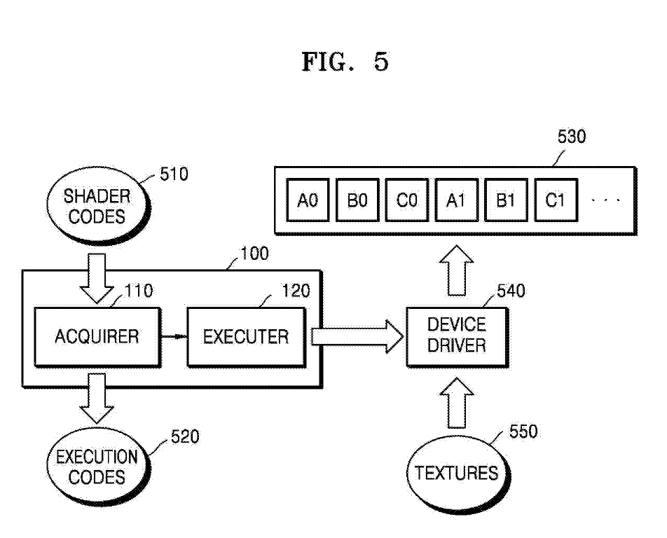

Hereinafter, an operation of the layout determining apparatus 100 is described in further detail with reference to FIG. 5.

FIG. 5 is a block diagram for explaining an operation of the layout determining apparatus 100 according to an embodiment.

In FIG. 5, operations of the layout determining apparatus 100 that compiles received shader codes 510 and stores textures 550 or mipmaps corresponding to the textures in a memory 530 are depicted.

The acquirer 110 receives the shader codes 510, compiles the shader codes 510, and outputs executing codes 520. Here, the executing codes 520 denote a result of compiling of the shader codes 510. The acquirer 110 may acquire information of textures required for pixel shading by compiling the shader codes 510. Accordingly, the acquirer 110 may acquire a pattern in which the textures are used when pixel shading is performed. For example, assuming that ‘Color=texture(A, coord)+texture(B, coord)+texture(C, coord)’ is included in the shader codes 510 as a code by which a color value of a specific pixel P is determined, the acquirer 110 may determine that a color value of the pixel P is determined based on a texture A, a texture B, and a texture C.

The executer 120 determines a layout of the textures 550 in the memory 530. For example, the executer 120 may determine a layout of the textures 550 in the memory 530 based on information, that is, a pattern in which the textures are used, of the textures 550 that are required for determining a color value of each pixel included in a frame. In further detail, the pattern in which the textures are used includes information, such as, what type of textures 550 are required for performing pixel shading and what type of texels in the textures 550 are required. Accordingly, the executer 120 may determine a layout of the textures 550 in the memory 530 in such a manner.

The executer 120 stores the textures 550 in the memory 530 according to the determined layout. For example, the executer 120 may store the textures 550 in the memory 539 through employing a device driver 540.

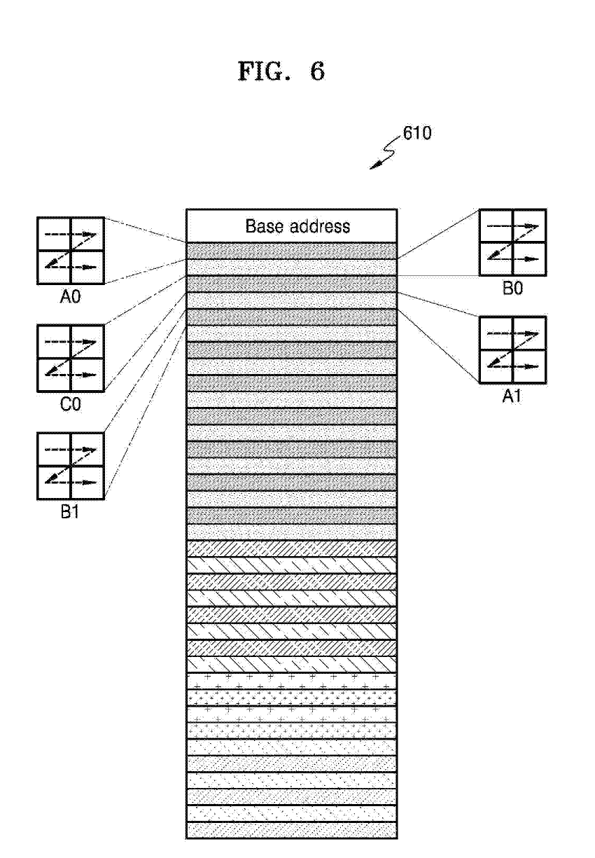

The texture layout determined by the executer 120 denotes a state in which the textures 550 are alternately stored in the memory 530 based on managing storage with a unit, such as a predetermined unit. Here, the unit, which may be a predetermined unit, may include four texels included in each of the textures 550. Hereinafter, an example layout of the textures 550 determined by the executer 120 is described further with reference to FIG. 6.

FIG. 6 is a drawing for explaining a layout of textures according to an embodiment.

A memory 610 as an example is depicted in FIG. 6. In FIG. 6, the memory 610 is depicted as including a single unit channel. However, the memory 610 may include a plurality of channels.

For example, with respect to FIG. 6, it is assumed that pixel shading is performed based on a texture A, a texture B, and a texture C. Also, it is assumed that units of four texels divided from the texture A are A0, A1, A2, . . . , units of four texels divided from the texture B are B0, B1, B2, . . . , and units of four texels divided from the texture C are C0, C1, C2 . . . in accordance with the discussion presented above.

As the acquirer 110 compiles shader codes, information with respect to the kind of textures or mipmaps corresponding to the textures that are required for pixel shading and the sequence and numbers of using the units that are divided from the textures may be acquired. Accordingly, the acquirer 110 may acquire a pattern in which the textures A, B, and C are used by using the information and approach described further above.

Also, the executer 120 determines a layout of the textures in the memory 610. For example, the executer 120 may determine a layout so that the units are stored in an order of ‘A0→B0→C0→A1→B1→C1→A2→ . . . ’ in the memory 610 to group the relevant information in a manner so that it may be retrieved in an manner that is most efficient and helpful.

However, the layout depicted in FIG. 6 is only an example of layouts that may be determined by the executer 120. Thus, the layout of the textures may vary in various ways. In other words, the executer 120 may determine the layout of the textures so that the time required for the GPU 20 to read the textures by accessing to the memory 410 for performing pixel shading is optimized or otherwise chosen in a manner that accomplishes a design goal with respect to how the information with respect to the textures is storage and retrieved.

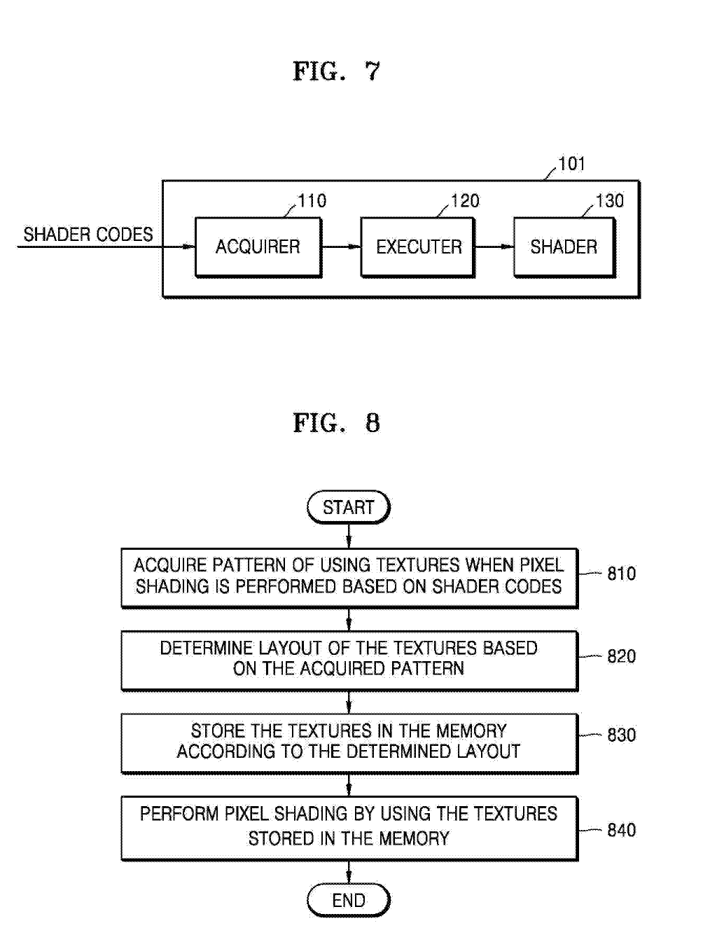

FIG. 7 is a block diagram of a configuration of a layout determining apparatus 101 according to another embodiment.

Referring to FIG. 7, the layout determining apparatus 101 may further include a shading unit or shader 130 in addition to the acquirer 110 and the executer 120.

The shader 130 performs pixel shading by using textures stored in a memory. Hereinafter, an operation of pixel shading by the shader 130 will be described with reference to FIG. 8.

FIG. 8 is a flowchart of a method of determining a layout of textures, according to another embodiment.

Referring to FIG. 8, the method of determining a layout of textures is configured of the operations that are time sequentially processed in the graphic processing system 1 depicted in FIGS. 1, 2, and 7 or the layout determining apparatus 100. Accordingly, although some contents are omitted in the following descriptions, the contents described with respect to the graphic processing system 1 depicted in FIGS. 1, 2, and 7 or the layout determining apparatus 100 may be applied to the method that will be described with reference to FIG. 8 with respect to understanding the steps presented in FIG. 8.

Operations 810 through 830 of FIG. 8 are the same as the operations 310 through 330 of FIG. 3. Accordingly, the descriptions with respect to the operations 810 through 830 are omitted for brevity.

In an operation 840, the method performs pixel shading by using the textures stored in a memory. For example, the shader 130 performs operation 840. In other words, the shader 130 performs pixel shading by using the textures stored in a memory. In other words, the shader 130 performs texture mapping by using the textures stored in the memory. The shader 130 may perform pixel shading by mapping 2D textures stored in the memory on a surface of an object that is expressed as 2D or 3D. For example, the shader 130 may perform planar mapping, cylindrical mapping, spherical mapping, automatic mapping, box mapping, bump mapping, opacity mapping, and reflection mapping, and so on.

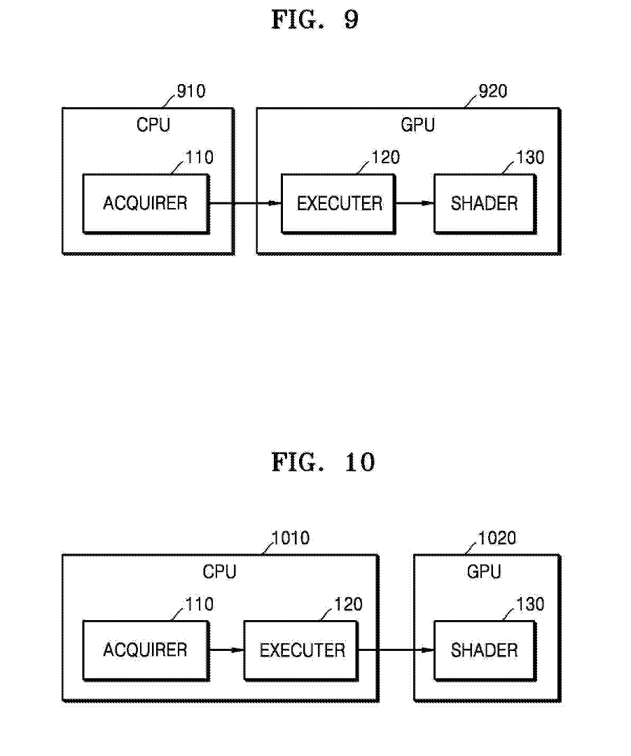

FIGS. 9 and 10 are block diagrams of example configurations of layout determining apparatuses according to another embodiment.

Referring to FIGS. 9 and 10, depicted are examples of realization of the layout determining apparatuses 100 and 101 described with reference to FIGS. 2 and 7 in the graphic processing system 1 described with reference to FIG. 1. Operations of the acquirer 110, the executer 120, and the shader 130 depicted in FIGS. 9 and 10 are the same as the operations described with reference to FIGS. 1 through 8. Accordingly, detail descriptions about the acquirer 110, the executer 120, and the shader 130 are omitted for brevity.

Referring to FIG. 9, the acquirer 110 may be included in a CPU 910. In other words, the CPU 910 may acquire a pattern in which the textures are used when pixel shading is performed based on shader codes.

The executer 120 and the shader 130 may be included in GPU 920. In other words, the GPU 920 may determine a layout of textures in a memory based on the pattern transmitted from the CPU 910. Also, the GPU 920 may store the textures according to the determined layout. Also, the GPU 920 may perform pixel shading by using the textures stored in the memory.

Referring to the example of FIG. 10, the acquirer 110 and the executer 120 may be included in a CPU 1010, and the shader 130 may be included in a GPU 1020. In other words, the CPU 1010 may acquire a pattern in which textures are used when pixel shading is performed based on shader codes. Accordingly, the CPU 1010 may determine a layout in a memory based on the acquired pattern.

Meanwhile, the GPU 1020 may perform pixel shading by using the textures stored in the memory.

According to the above descriptions, the layout determining apparatus 100 stores textures in the memory 30 according to the pattern in which the textures are used when pixel shading is performed. As a result, the time for the GPU 20 to read the textures by accessing to the memory 30 may be minimized. In other words, in accessing for the GPU 20 by the memory 30, the possibility of causing a row hit is increased and the possibility of a causing bank conflict may be reduced. As a result, performance improves.

The apparatuses, units, modules, devices, and other components such as acquirers, executers, and shaders illustrated in FIGS. 1-10 that perform the operations described herein with respect to FIGS. 1-10 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-10. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described herein with respect to FIGS. 1-10 are performed by computing hardware, for example, by one or more processors or computers, as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of determining a layout of textures, the method comprising:
acquiring a pattern of using the textures when pixel shading is performed, based on shader codes;
determining a layout of the textures based on the acquired pattern; and
storing the textures in a memory according to the determined layout.

2. The method of claim 1, wherein the storing of the textures in the memory comprises alternately storing the textures in units in the memory.

3. The method of claim 2, wherein the units comprise four texels in each of the textures.

4. The method of claim 1, wherein the acquiring of the pattern comprises acquiring the pattern during compiling of the shader codes.

5. The method of claim 1, wherein each of the textures comprises at least one mipmap corresponding to each of the textures.

6. The method of claim 5, wherein a reduction ratio between mipmaps is 1/4.

7. The method of claim 5, wherein the mipmaps are stored in the memory in the order of the textures.

8. The method of claim 1, wherein the memory comprises dynamic random-access memories (DRAMs).

9. The method of claim 1, further comprising performing pixel shading based on the textures stored in the memory.

10. The method of claim 1, wherein the pattern indicates in what order and what part of each of the textures are to be used when pixel shading is performed.

11. A computer program embodied on a non-transitory computer readable medium, the computer program being configured to control a processor to perform the method of claim 1.

12. A layout determining apparatus comprising:
one or more processors configured to:
acquire a pattern of using textures when pixel shading is performed, based on shader codes; and
determine a layout of the textures based on the acquired pattern and store the textures in a memory according to the determined layout.

13. The layout determining apparatus of claim 12, wherein the layout of the textures comprises alternately storing the textures in units in the memory.

14. The layout determining apparatus of claim 13, wherein the units comprise four texels in each of the textures.

15. The layout determining apparatus of claim 12, wherein the one or more processors are further configured to acquire the pattern during compiling the shader codes.

16. The layout determining apparatus of claim 12, wherein each of the textures comprise at least one mipmap.

17. The layout determining apparatus of claim 12, wherein the memory comprises dynamic random-access memories (DRAMs).

18. The layout determining apparatus of claim 12, the one or more processors are further configured to perform pixel shading based on the textures stored in the memory.
